(19) United States
(12) Patent Application Publication
(10) Pub. No.: US 2021/0081459 A1
(43) Pub. Date: Mar. 18, 2021

(54) NOTIFICATION SYSTEM FOR A COLLABORATION TOOL CONFIGURED TO GENERATE USER-SPECIFIC NATURAL LANGUAGE RELEVANCY RANKING AND URGENCY RANKING OF NOTIFICATION CONTENT

(71) Applicants: Atlassian Pty Ltd., Sydney (AU); Atlassian Inc., San Francisco, CA (US)

(72) Inventor: Sukho Chung, San Francisco, CA (US)

(21) Appl. No.: 16/575,249

(22) Filed: Sep. 18, 2019

(51) Int. Cl. G06F 16/9032; G06F 16/9038; G06F 16/332; G06F 17/27

(52) U.S. Cl. CPC G06F 16/90332; G06F 17/2785; G06F 16/3326; G06F 16/9038

(57) ABSTRACT

A collaboration tool configured to generate natural language urgency and relevancy scores, and to display said scores, with notifications sent to users of the collaboration tool. In this manner, and as a result of these constructions, a user of the collaboration tool can immediately and quickly understand which notifications from the collaboration tool should be acted upon first.

### TECHNICAL FIELD

Embodiments described herein relate to collaboration tools and, in particular, to systems and methods for enriching notifications to users of a collaboration tool of by determining and displaying a natural language and user-specific relevance and urgency score/rank based on content of a notification to be delivered to the specified user.

### BACKGROUND

An organization can leverage a collaboration tool that is accessible by many individuals to facilitate completion of work related to a goal. Many conventional collaboration tools and interfaces are configured to generate notifications—including email notifications, browser notifications, mobile/native application notifications, and the like—to users of the collaboration tools to provide information to those users and, additionally or alternatively, to solicit input or action from those users.

In many cases, however, a user of a conventional collaboration tool configured to provide notifications to that user may receive, from time to time, a large quantity of notifications from the collaboration tool. In such cases, the user is left to sort, filter, and/or otherwise triage notifications and to manually determine which notifications or content should be consumed and/or acted upon first, often resulting in inefficiencies and, in some cases, delayed responses to time-sensitive notifications or content inadvertently overlooked by the user.

### SUMMARY

Certain embodiments described herein relate to methods for operating a content scoring server. The content scoring server can be associated with, or allocated as a portion of, a collaboration tool, such as described herein.

An example method described herein operates a content scoring server to autonomously generate a natural language relevancy rank and urgency rank of specified content to be displayed to a specified user of the collaboration tool. In particular, such a method includes the operations of: receiving, at the content scoring server, a first data item with the specified content and a second data item corresponding to the specified user; extracting a content feature set, entirely or partly by the content scoring server or another device (e.g., a client application communicably coupled to the content scoring server or the collaboration tool), from the first data item; generating a query set, entirely or partly by the content scoring server or another device, with at least one of the content feature set and the second data item; and querying, by the content scoring server, at least one database with at least one query of the query set to obtain a query result.

In such embodiments, and other related implementations, the query result includes at least one of (1) a first dataset of user interaction events corresponding to interactions by the specified user with content with at least one feature of the content feature set and (2) a second dataset of user interaction events corresponding to interactions by at least one other user of the collaboration tool with content with at least one feature of the content feature set.

The method advances to leverage the query set by performing the operations of: ingesting by a predictive model hosted by the content scoring server, the query result, the first data item, and the content feature set; receiving, from the predictive model, (1) a first probability metric representing a likelihood that the specified user will interact with the specified content, and (2) a second probability metric representing a likelihood that the specified user will interact with the specified content within a threshold period of time; determining, by the content scoring server, a relevancy rank by selecting a first natural language descriptor (also referred to herein as a “natural language phrase”) based on the first probability metric; determining, by the content scoring server, an urgency rank by selecting a second natural language descriptor based on the second probability metric; and, finally, instructing, by the content scoring server, a notification server to generate a notification to the specified user, the notification with the specified content, the relevancy rank, and the urgency rank. The notification can be any suitable notification. Examples include an email notification, a native application notification, a browser notification, or banner notification.

In still other embodiments, other configurations are possible. For example, some embodiments include a configuration in which the query result referenced above includes at least two of (1) the first dataset, (2) the second dataset, (3) a third dataset with metadata describing at least one feature of the content feature set, and (4) a fourth dataset with a tag assigned by the specified user describing at least one feature of the content feature set.

Still other embodiments include a configuration in which the query result referenced above includes each of the first dataset, the second dataset, the third dataset, and the fourth dataset.

Some embodiments include a configuration in which the query results includes first dataset and at least one user interaction event includes a dwell time of the specified user relative to content with at least one feature of the content feature set.

Some embodiments include a configuration in which the query results includes second dataset and the at least one other user may be a member of team (e.g., supervisor, coworker, subordinate, manager, and so on) with the specified user. Some embodiments include a configuration in which the team may be associated with a project tracked by the collaboration tool.

Some embodiments include a configuration in which the notification server is configured to communicate with a client device associated with the specified user and communicably coupled to the collaboration tool, and the notification server may be configured to instruct the client device to display the notification to the specified user.

Some embodiments include a configuration in which the client device is configured to display the urgency rank and the relevancy rank in addition to at least a portion of the specified content.

Some embodiments include a configuration in which the at least a portion of the specified content includes one or more of a content title, a metadata item describing the specified content, at least one content feature of the content feature set, and a content body. Some embodiments include a configuration in which the metadata item includes one or more of a content author and a content creation date.

Some embodiments include a configuration in which the client device that displays the notification to the specified user is configured to display to the specified user a relative time difference between a time at which the notification is displayed and the content creation date.

Some embodiments include a configuration in which the content feature set includes one or more of a set of lemmatized words extracted from the specified content, a topic model, generated by the content scoring server, from the specified content, and a sentiment analysis, performed by the content scoring server, of at least a portion of the specified content.

Still further embodiments described herein relate to a content scoring server in communication with a collaboration tool platform. The content scoring server includes a networking resource allocation (which may be physical or virtual), a memory resource allocation (which may be physical or virtual), and a processor resource allocation (which may be physical or virtual).

The processor resource allocation is in communication with the memory resource allocation and the networking resource allocation. In addition, the processor resource allocation is configured to execute instructions retrieved from the memory resource allocation to: receive the specified content and an indication of the specified user; generate at least one query based on at least one semantic feature of the specified content and based on the specified user; submit the at least one query, via the networking resource allocation, to a database to obtain a result with at least one of a dataset of user interaction events corresponding to interactions by the specified user and other users of the collaboration tool platform with content with the at least one sematic feature of the specified content; ingest by a predictive model loaded from the memory resource allocation by the processor resource allocation, (1) the query result and (2) the indication of the specified user; receiving, from the predictive mode (1) a first probability metric representing a likelihood that the specified user will interact with the specified content and (2) a second probability metric representing a likelihood that the specified user will interact with the specified content within one of a set of threshold periods of time; and initiating a process to cause a notification to be displayed to the specified user at a client device of the specified user. As with other examples described herein, the notification includes the at least a portion of the specified content, the first probability metric, and the second probability metric.

Some implementations of these and other embodiments include a configuration in which the processor allocation is configured to (1) translate the first probability metric to a first natural language descriptor and (2) translate the second probability metric to a second natural language descriptor. In these examples, the notification includes the first natural language descriptor and the second natural language descriptor.

Some embodiments include a configuration in which at least one threshold of the set of threshold periods of time is satisfied when the specified user interacts with the specified content within an hour of the notification being shown to the specified user.

Some embodiments include a configuration in which at least one threshold of the set of threshold periods of time is satisfied when the specified user interacts with the specified content within a week of the notification being shown to the specified user.

Some embodiments include a configuration in which the specified content may be associated with a task assigned to the specified user that may be related to a project or a knowledge-sharing feature tracked by the collaboration tool.

Embodiments described herein relate to method for autonomously generating and displaying, in natural language, an urgency score corresponding to a prediction of whether specified content to be displayed to a specified user of a collaboration tool is likely to require the urgent attention of the specified user.

In particular, such methods include the operations of: receiving the specified content and an indication of the specified user; extracting at least one semantic feature from the specified content; querying a database of user interaction events corresponding to interactions by users of the collaboration tool with content with the at least one semantic feature extracted from the specified content to obtain a dataset of user interaction events corresponding to interactions by the specified user and other users of the collaboration tool with the content with the at least one semantic feature extracted from the specified content; receiving by a predictive model the dataset and the indication of the specified user; generating by the predictive model, from the dataset and the indication of the specified user, a probability metric representing a likelihood that the specified user will interact with the specified content within one of a set of increasing threshold periods of time; translating the probability metric into the urgency score, the urgency score comprising a natural language phrase based on a magnitude of the probability metric; and, finally, generating a notification to the specified user that includes the specified content and the natural language phrase.

Some embodiments include a configuration in which the natural language phase may be selected from the English language phrase group including: high urgency, low urgency, medium urgency, not urgent, and not relevant. It may be appreciated that these examples are not exhaustive and that in other embodiments, other phrases can be used. In still other examples, non-English phrases or words can be used including other natural languages, icons, emojis, abbreviations, punctuation, and so on.

The semantic feature can be, without limitation: a topic model derived from the specified content; a word count of the specified content; a sentence count of the specified content; a keyword list extracted from the specified content; a name or alias identifying the selected user extracted from the specified content; a name or alias identifying a supervisor of the selected user extracted from the specified content; a name or alias identifying a subordinate of the selected user extracted from the specified content; a name or alias of a project tracked by the collaboration tool extracted from the specified content; and a sentiment analysis of at least a portion of the specified content.

Some embodiments include a configuration in which at least one user interaction event of the dataset includes a dwell time taken by the specified user over content with the at least one semantic feature.

Some embodiments include a configuration in which at least one user interaction event of the dataset includes an average dwell time taken by a set of users of the collaboration tool over content with the at least one semantic feature.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 is a schematic representation of a collaboration tool including a content scoring server, such as described herein.

FIG. 2A depicts an example user interface that may be associated with a collaboration tool, such as described herein.

FIG. 2B depicts another example user interface that may be associated with a collaboration tool, such as described herein.

FIG. 3A depicts another example user interface that may be associated with a collaboration tool, such as described herein.

FIG. 3B depicts another example user interface that may be associated with a collaboration tool, such as described herein.

FIG. 4 is a flow chart that depicts example operations of a method of operating a content scoring server, such as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

An example of a collaboration tool, as described herein, is a project management system or tool that can be implemented in whole or in part as software executed by a virtual or physical server or other computing appliance or combination of appliances that provides a team of individuals with a method for communicating and exchanging information with one another. An example of a collaboration tool is a messaging board, a forum, a wiki, a project management system, an issue tracking system, and the like.

In some examples, a collaboration tool is configured for use by a software development team to exchange information that can facilitate the completion and assignment of discrete tasks related to software development projects from creation of new user stories (i.e., user-perspective feature requests or desired functionality), through proof of concept testing, through integration testing, through release of software to one or more users, and through reporting and fixing of software errors (“bugs”).

In other cases, a collaboration tool can be configured for non-software related purposes, such as for use by a human resources team, an information technology support group, and so on. It may be appreciated that a collaboration tool, such as described herein can be used to exchange files, text content, or information, facilitate text, audio, or video communication, or any other suitable collaboration or communication purpose. In this manner, a collaboration tool increases efficiency of a team of individuals working on a common goal or project by increasing the speed by which information can be shared between team members, between supervisors and subordinates, and between management and staff.

In addition, in many conventional implementations, a collaboration tool can include a notification system and/or notification server configured to generate and deliver notifications, such as email notifications, banner notifications, or browser-based notifications, directed to one or more users of the tool. In one example, a notification can be sent to a user when particular content tracked, stored, or otherwise available to (or conveyed by) the collaboration tool is added, changed, or removed.

In other cases, notifications can be provided for other purposes. Examples include, but are not limited to: a notification to a first user that a second user of the same collaboration tool has mentioned the first user in a post, comment, or other content tracked or consumed by the collaboration tool or a system connected thereto; a notification to a user that content tagged by that user has been changed or updated; a notification to a user that content added by that user has been changed or updated; a notification to a user that content created by that user has received a comment from another user; a notification to a user that a project belonging to that user has changed (e.g., a new task has been assigned to the user or another user, a new story has been added, a new epic has been added, and so on); and so on. It may be appreciated that the foregoing examples are not exhaustive; a notification such as described herein can be sent for any suitable purpose. In other embodiments, a “notification” such as described herein may be referred to by another term or phrase such as, without limitation: a banner; a note; an informative content item; a metadata item; an alert; an announcement; and so on.

Similarly, a notification such as described herein can include and/or can be accompanied by any number of suitable data items and/or content. For example, a notification such as an email notification can include, without limitation: a title; a send date; a received date; a display date; a read date; text, video, image, and/or audio content; tags; one or more user identifiers (e.g., a username, a user alias, a user name, and so on); a profile photo, icon, emoji, picture, or avatar; an attachment; an anchor link to other content stored by the collaboration tool (e.g., a content server), another service, or a third party; and so on. It may be appreciated that the foregoing examples are not exhaustive; a notification such as described herein can be include any suitable content or combination of contents. In some examples, a notification may be provided, sorted, or otherwise presented to a user as its own entity (e.g., an email notification or a native application notification), whereas in other embodiments, a notification can be displayed and/or otherwise provided in-line (or otherwise included with) with other content related to that notification (e.g., a banner notification may be generated within or around content related to that notification, such as a blog post or a wiki article).

More particularly, a notification such as described herein can display all or some of its contents or metadata in any suitable or implementation-specific manner. For example, in some embodiments, a notification such as an email notification can include among other data items or contents, a body, a title, and a sender. In these examples, a system such as described herein can be configured to display to a user of that system the title and the sender prior to showing the body of the notification to the user. In this manner, multiple notifications can be compactly displayed next to one another in a list, grid, or other graphically organized manner so that a user who receives multiple notifications can understand with confidence what the body of the notification contains.

In other cases, a collaboration tool, such as described herein can be configured to generate a summary of the body by supplying the body of a particular notification as an input to a natural language processing pipeline, processing system, trained or untrained linguistic model, or any other suitable natural language processing system. In these embodiments, a system such as described herein can be configured to display the autonomously-generated summary of the notification body to the user prior to displaying for that same user the complete body contents of the notification.

In still other embodiments, a collaboration tool such as described herein can be configured to display one or more contents of a notification inline and/or otherwise with other content served by the collaboration tool to be consumed by a user of that tool. For example, a banner notification displayed above content in a knowledge sharing feature hosted and served by an example collaboration tool can include information related to the other contents of that page.

In view of the several foregoing examples, it may be appreciated that these foregoing examples are not exhaustive; a person of sill in the art can understand that any suitable quantity of information (which may vary from notification to notification or embodiment to embodiment) can be displayed in any suitable manner to a user to provide that user with information and/or to solicit input or action from that user.

As such, for simplicity of description, the embodiments that follow reference an email notification as an example notification that can be sent by a system such as described herein. In these examples, the email notification can be sent as an email message to a particular email address associated with a particular user. The email message can be displayed to that user alongside other email messages received by that user. The email message, in many embodiments, can be initially displayed in an abbreviated format that hides one or more content items (e.g., email body, email multimedia content, and so on) from the user until the user affirmatively interacts with the abbreviated notification. In a more simple phrasing, a system such as described herein may be configured to display, prior to interaction by a user, a subset of information contained in the email message itself.

For example, the system may be configured to display to the user a message receive date, a message priority flag, a message sender, and a message subject. Once the user clicks or otherwise interacts with (in any suitable manner including dwell time, click-through, cursor hover, and so on) the abbreviated message, additional content of the email message can be shown, such as the email body. Thereafter, the user may interact with the complete content of the message (e.g., via clicking through a link, performing a task in another application, performing or initiating a task in the collaboration tool, hovering over particular content, dwelling for a particular period of time or beyond a threshold period of time, and so on.).

In many cases, however, and as noted above, a user of a collaboration tool may receive a high quantity of notifications that limits that user's productivity and responsiveness to those notifications and/or contents thereof. Phrased in another, non-limiting manner, a user of a collaboration tool may receive a number of email notifications from that collaboration tool and, as a result, the user may unintentionally overlook one or more messages to which the user would have otherwise responded to promptly or with high urgency.

Many conventional notification systems do not address this issue and, instead, leave as a task for the user the task of sorting, prioritizing, or otherwise triaging messages and notifications. As noted above, this technique does not provide any assistance to users who receive a high number of notifications and can result in lower productivity for those users.

Other conventional notification systems attempt to address this problem by performing a hidden or otherwise obfuscated calculation that categorizes some messages or notifications as unwanted email (e.g., spam or junk). This technique does not provide useful assistance to users who receive a high number of notifications because, in many examples, messages of importance to a user may be hidden from that user, requiring additional steps of the user to review all messages received.

Still other conventional notification systems attempt to perform a hidden or otherwise obfuscated calculation to categorize messages received into one of a limited set of categories (e.g., social media messages, ecommerce messages, service notifications, spam messages, and so on). This technique does not provide useful assistance to users who receive a high number of notifications because, in many example, messages sent from a single source or related to a single platform or tool are categorized in the same manner; a user is not able to readily prioritize or categorize messages received from the same platform, such as a collaboration tool, such as described herein.

Still other conventional notification systems perform a hidden or otherwise obfuscated calculation to sort or otherwise order messages into an order that the conventional system determines without input from the particular user for which the notifications were intended. This technique does not provide useful assistance to users who receive a high number of notifications because, in many examples, messages of importance to a user may be hidden from that user, requiring additional steps of the user to review all messages received. In other words, because the methodology used by the conventional system is hidden from the user, the user cannot audit the effectiveness or provide input on the effectiveness of that methodology.

Furthermore, by sorting all notifications based on a single metric, the user cannot prioritize messages based on importance without reviewing all messages sorted by the system. For example, a message received several weeks ago may be sorted to the top of a list of more recently-received notifications by a conventional system simply because that message is old and has yet to be “read” by the user. In another example, a message received today may require urgent and immediate attention, but may get deprioritized by a conventional system.

In a simpler phrasing, conventional notification systems, such as these described, cannot account for both objective importance (e.g., message flags, sender identity, and so on) to a particular user and for subjective importance (e.g., urgent to respond to now due to time sensitivity; not urgent to respond to now, but will be urgent tomorrow; urgent to respond to now because message is nearly stale; urgent to respond to because supervisor is copied; not urgent to respond to because user is not a direct recipient; and so on) to the particular user.

To account for these and many other shortcomings of conventional notification systems and collaboration tools, embodiments described herein include further include a content scoring system and/or server—referred to herein as a “content scoring server”—interposing the notification system and the user (e.g., the recipient of a notification) and configured to generate a readily-understandable and quickly-consumable natural language indication of relevance and urgency (referred to herein as “urgency” scores or ranks and “relevancy” scores or ranks) of particular specified content relative to a particular specified user. These scores correspond to statistical predictions of likelihood(s) that a particular user will interact with particular content in a particular way and/or within a particular time frame.

For example, these systems described herein can be configured to determine likelihoods such as, but not limited to: a likelihood that a particular user, when seeing a particular word or phrase, will exhibit increased dwell time; a likelihood that a particular user, when seeing a particular sender of a notification will click through to view content associated with that notification; a likelihood that a particular user, when seeing a notification subject containing specific words, phrases, or topics, will initiate or complete a task; a likelihood that a particular user will perform a specific interaction (e.g., dwell time, click-through, hover, and so on) with particular content; a likelihood that a sender of a notification expects an action from the user; and so on.

The likelihood(s) calculated or otherwise determined herein can be probabilities (e.g., a number from 0 to 1), percentages (e.g., a number from 0 to 100), probability distribution functions, probability density functions, and so on. In many cases, Monte Carlo simulation or other simulation techniques can be used to obtain one or more discrete values (e.g., mode, mean, deviation, and so on) from a probability density function, although this is one example; others are possible.

As a result of these constructions and techniques for presenting information/information to the specified user, the user can make informed decisions about whether that user should consume content of the notification immediately, at the user's convenience, or not at all.

In other words, a result of these constructions and presentations of data for a user, (1) a user can quickly identify which messages should receive the user's priority attention , (2) no messages received need be hidden from that user, and/or (3) messages received from a single source or sender can be prioritized and/or sorted alongside messages received from other sources or senders.

In these examples, the urgency and relevancy “scores” (also referred to as “ranks”)—which can be presented in natural language (e.g., “high,” “medium,” “low,” and so on) graduated or scaled indicia and/or graphical form (e.g., red, orange, green icons or formatting) to facilitate rapid comprehension by a user of the collaboration tool when such phrases/scores are displayed alongside notification content. In this manner, and as a result of this presentation, each user of a collaboration tool can readily and easily determine which notifications received by that user should be acted upon and in which order, without requiring the user to review spam or junk folders, high-level message categorization buckets, or the like.

In other words, each user of a collaboration tool (or issue tracking system, or content service, or the like), such as described herein, can readily understand which, of notifications sent to that user, require the user's “urgent” attention (e.g., which notifications should be acted upon quickly after receiving the notification), and which of those notifications are likely to be “relevant” to that user (e.g., which notifications refer to or contain content that can or eventually will be acted upon by the user). In this manner, time taken by a user to sort through and/or otherwise prioritize a group of notifications can be substantially reduced and, thus, output from a team leveraging a collaboration tool such as described herein can be substantially increased.

A content scoring server, such as described herein, is configured to leverage information stored by the collaboration tool, such as user interaction events (e.g., dwell time, click-through, first click, last click, cursor path, and so on) or other metadata or information (e.g., content creator, creation date, content title, semantic content, and so on), to (1) determine statistical likelihood of whether a particular user is likely to interact with particular content at all and (2) if the user is likely (e.g., greater thank a threshold confidence; 10%, 50% 80% likelihood and so on) to interact with that content, to determine a second statistical likelihood of whether that particular user is likely to interact with the particular content within a particular time interval (e.g., seconds, minutes, hours, days, weeks, months, and so on). As with other embodiments described herein, the “interaction” predicted can be a particular interaction (or type) or at least one of a set of interactions or interaction types. Examples include, but are not limited to: clicking a particular anchor element (and/or a time at which such an interaction may be performed by the user after the users first observes the notification); clicking a particular media element (and/or a time at which such an interaction may be performed by the user after the users first observes the notification); playing a particular media element (and/or a time at which such an interaction may be performed by the user after the users first observes the notification); dwelling over text content for at least a threshold time (and/or a time at which such an interaction may be performed by the user after the users first observes the notification); selecting text (and/or a time at which such an interaction may be performed by the user after the users first observes the notification); and so on and the like.

In a more simple phrasing, a content scoring system such as described herein is configured to make two determinations. A first determination of whether a user is likely to interact with particular content and a second determination of whether the user is likely to interact with particular content within a particular time interval. The first determination corresponds to a determination of “relevancy” to the specific user and the second determination corresponds to a determination of “urgency” to the specific user. In this manner, it may be implied that for a content item to be urgent for a particular user, that content item should enjoy at least minimal relevance to that user.

For example, a notification with content referring to a water leak may be highly relevant and highly urgent to custodial staff of the building suffering the leak, whereas the same notification may have low or no relevance or urgency to a staff member working from another office. In another more specific example, a notification reporting a new bug in a software application that relates to user privacy may be highly relevant and highly urgent to a manager of a team responsible for information security, whereas the same notification may be of moderate relevance and moderate urgency to a junior member of that same team, whereas the same notification may be of low or no relevance to users of another team that receives bug report notifications.

In other cases, urgency and relevance may take other definitions or meanings. In some embodiments, urgency scores and/or relevancy scores (and/or calculating the same) can be configurable by a user, a user's supervisor, or by any other person. For example, urgency may be defined to require that a user initiate a particular task after receiving a notification; if it is predicted by a calculated likelihood that a user will not initiate the particular task, the notification may not be considered urgent. In other cases, relevancy may be defined by the user's particular project or workload at a particular time; a notification related to a project the user has not interacted with for a threshold time (e.g., days, weeks, months) may be of low relevance and of low importance to the user. In other cases, a project that the user was recently assigned to may enjoy higher relevance and higher urgency to that user. In a more simple and non-limiting phrasing, it may be appreciated that urgency and relevance on a per-user basis may enjoy different definitions from embodiment to embodiment and any suitable method of determining a likelihood of a user reacting or acting in a particular way (or, oppositely, not reacting or acting in a particular way) may be used. For simplicity of description, many embodiments that follow reference urgency that is associated with and that corresponds to a prediction that a particular user will perform at least one interaction with content displayed for that user within a particular selected timeframe; the faster the user is predicted to interact with said content, the higher the urgency is to that user. It is appreciated, however, that this is merely one example definition of urgency; other definitions and methods of determining urgency can be used.

After user-specific and content-specific statistical likelihoods related to urgency and relevancy are calculated or otherwise determined, a content scoring server—such as described herein—can translate those statistical likelihood(s) into a natural language relevancy score and a natural language urgency score.

For example, if a content scoring server determines—after querying a database of user interactions with content stored by, or accessible to, the collaboration tool—that a notification (or content referenced thereby) is semantically similar to content that a particular user has regularly interacted with, the content scoring server can assign a natural language phrase of “high relevance” to the new notification prior to sending that notification to the intended recipient user.

Similarly, if the content scoring server determines that the notification contains particular phrasing or is semantically similarly to at least one of a set of identified or particular phrases that have appeared in other notifications that were acted upon quickly (e.g., faster than average for all notifications or a subset of notifications sent by the collaboration tool to a particular user or a set of particular users of the collaboration tool) by users who received said notifications, the content scoring server can assign a natural language phrase of “high urgency” to the new notification prior to sending that notification to the intended recipient user. In another example, the content scoring server can determine that the specified user's supervisor has interacted with content related to the notification frequently in the past week or month In this example, the content scoring server can assign a natural language phase of “high urgency to supervisor” to the notification. Other example urgencies include, but are not limited to: high urgency to client; high urgency to report/employee; high urgency to vendor; high urgency to executives; high urgency to epic; high urgency to user story; high urgency to legal department; and so on. In still other cases, urgency can be determined and/or influenced or biased by: a timeline or due date; a budget; a request; a manually-assigned tag; and so on.

The content scoring server, in these and other examples, can determine natural language phrases that correspond to urgency scores and relevancy scores in any suitable manner by leveraging any suitable data stored by, or accessible to, a collaboration tool such as described herein. For example, as noted above, an urgency score can be determined by calculating a statistical likelihood (e.g., using Bayesian analytics or analysis or any other suitable method or combination of methods) that a particular user will interact with particular content within a particular time window, or at least before a particular time threshold expires.

Similarly, a relevancy score can be determined by calculating a statistical likelihood (e.g., using Bayesian analytics or analysis or any other suitable method or combination of methods) that a particular user will interact with particular content at any given time. In other words, as noted above, a “relevancy score” is associated with a statistical prediction or likelihood that a particular user will interact with or otherwise act upon particular content in, or referenced by, a notification sent to that user and an “urgency score” is associated with a statistical prediction or likelihood that a particular user will interact with, or otherwise act upon, particular content in, or referenced by, a notification sent to that user within a particular period of time after the user receives (e.g., opens or reads the notification) that notification.

For example, if a content scoring server determines that a particular user has a greater than 80% chance of acting upon a notification that includes the phrase “ventilation failure” within one hour of receiving the notification, the content scoring server can assign an urgency score of “high urgency.” In this example, the system can further determine that due to the particular user's regular interaction with content semantically related (e.g., lemmatized bag of words, topic modeling, Levenshtein or cosine distance calculations, or any other suitable method) to “cooling systems,” the notification referencing “ventilation failure” has a 90% chance of being acted upon (e.g., interaction of a particular interaction type or among a set of interaction types) by that user. In this example, the content scoring server can assign a relevancy score of “highly relevant.” As with other embodiments described herein, the output(s) from the content scoring server (i.e., the urgency score and the relevancy score) can be appended to, or otherwise merged with the contents of, the notification and can be displayed to the user alongside the notification contents.

In this manner, and as a result of this presentation, the user's attention can be quickly drawn to the notification and the notification can be acted upon in a more time efficient manner, as the user is not required to sort through and/or read through all unread notifications; the user's attention can be quickly drawn to the natural language text of “high urgency” and “high relevance.” In some examples, such text can be formatted in a manner to solicit the user's attention. For example, “high relevance” and “high urgency” may both be displayed in a red color. In other cases, one or both of the relevancy score or urgency score can be displayed in an animated manner (e.g., flashing, pulsing, moving, and so on). As a result of these presentations, which are not exhaustive, a user's attention can be quickly drawn and the notification can be quickly acted upon.

In another example, if the content scoring server determines that a particular user has a less than 10% chance of acting upon a notification that includes the phase “user 1 liked your comment,” within one week of receiving the notification (e.g., based on the user's interaction history with semantically similar content or content having a similar topic model), the content scoring server can assign an urgency score of “not urgent.”

In this example, the system can further determine that due to the particular user's infrequent interaction with content related to “likes” or other social media event notifications, the notification referencing another user “liking” the particular user's comment has a 5% chance of being acted upon by that user. In this example, the content scoring server can assign a relevancy score of “not relevant.” Again, as with other embodiments described herein, the output(s) from the content scoring server can be appended to—or otherwise transmitted or communicated with—the notification and can be displayed to the user alongside the notification contents. In this manner, and as a result of this presentation, the user's attention can be avoided and other, higher priority, notifications can be acted upon first. As with other examples, in this example, such text can be formatted in a manner to not solicit the user's attention (e.g., displayed in a muted or transparent gray color). As a result of these presentations, which are not exhaustive, a user's attention can be diverted to other, higher relevancy or higher urgency matters so that those notification can be quickly acted upon.

It may be appreciated that any suitable data can be used to inform an urgency score or a relevancy score, determined by a content scoring server such as described herein. Further, it may be appreciated that the same notification may have different relevance and different urgency to different users of the same collaboration tool.

Example data items that may be used to inform a calculation or a determination of an urgency score or, more generally, example data items that may be used to calculate a statistical likelihood that a user will interact with particular content within a particular time window (e.g., before expiration of a selected time threshold) include, but are not limited to: a number of user interaction events (e.g., dwell time, click-through, cursor hover, first click, last click, and so on) by a particular or selected user with semantically, grammatically, syntactically similar content (e.g., user-specific interaction events); metadata describing one or more user interaction events (e.g., time to first interaction, time to click-through, average scroll speed, time to dismiss notification, and so on) by a particular or selected user with semantically, grammatically, syntactically similar content (e.g., user-specific interaction events); a number of user interaction events by a particular group of users working with a selected user to similar content (e.g., team-specific interaction events); a number of user interaction events by any user working on a particular project (e.g., organization-specific interaction events); a number of user interaction events by any user with respect to particular content (e.g., global interaction events); and so on. These example data items, and others, can also be used to determine a relevancy score, such as described herein.

It may be appreciated that these foregoing examples are not exhaustive; any number of suitable determinations can be made by a content scoring system or server, such as described herein and, similarly, any number of suitable natural language phrases can be used to correlate or otherwise quantize a statistical likelihood into a natural language phrase.

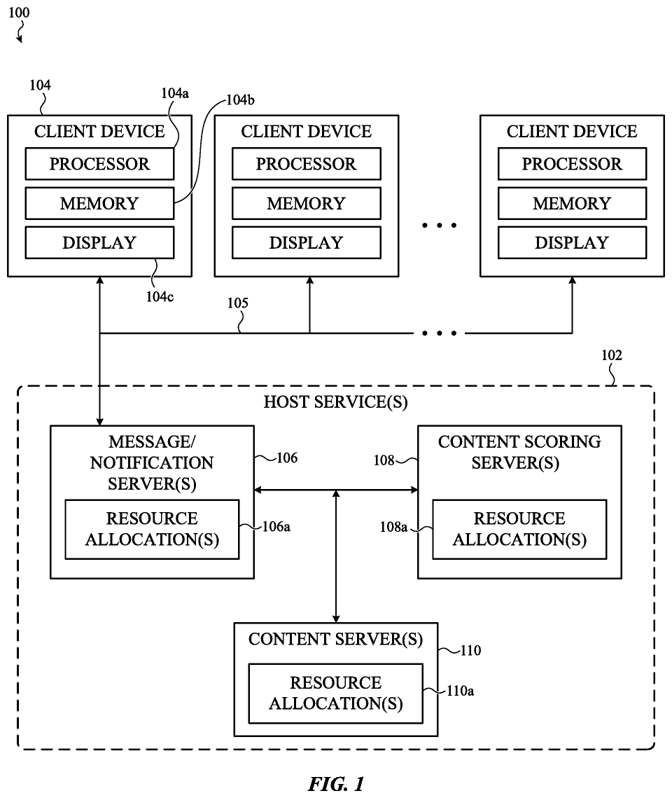

These foregoing and other embodiments are discussed below with reference to FIGS. 1-4. However, those skilled in the art will readily appreciate that the detailed description given herein with respect to these figures is for explanatory purposes only and should not be construed as limiting.

FIG. 1 is a schematic representation of a portion of an example collaboration tool that can provide notifications or other content with urgency and relevancy scores, such as described herein. In the illustrated embodiment, the collaboration tool 100 is implemented with a client-server architecture including a host service 102 that communicably couples (e.g., via one or more networking or wired or wireless communication protocols) to one or more client devices, one of which is identified as the client device 104.

It may be appreciated that other client devices may be configured in a substantially similar manner as the client device 104, although this may not be required of all embodiments and different client devices can be configured differently and/or may transact data or information with, and/or provide input(s) to, the host service 102 in a unique or device-specific manner.

The client device 104 can be any suitable personal or commercial electronic device and may include, without limitation or express requirement, a processor 104a, volatile or non-volatile memory (identified, collectively, as the memory 104b), and a display 104c. Example electronic devices include, but are not limited to: laptop computers; desktop computers; cellular phones; tablet computing devices; and so on. It may be appreciated that a client device 104, such as described herein, can be implemented in any suitable manner.

In many embodiments, the processor 104a of the client device 104 can be configured to execute an application (herein referred to as a “client application”) stored, at least in part, in the memory 104b. The client application is configured to access and communicate with the host service 102 and to securely transact information or data with, and provide input(s) to, the host service 102. In some embodiments, the client application may be a browser application configured to access a web page or service hosted by the host service 102 that is accessible to the client device 104 over a private or public network that may, in some embodiments, include the open internet.

In many embodiments, the host service 102 is configured to operate within or as a virtual computing environment that is supported by one or more physical servers including one or more hardware resources such as, but not limited to (or requiring) one or more of: a processor; a memory; non-volatile storage; networking connections; and the like. For simplicity of description and illustration, these example hardware resources are not shown in FIG. 1.

In many embodiments, the host service 102 can include a number of discrete subservices or purpose-configured modules, containers, or virtual machines each configured to perform, coordinate, serve, or otherwise provide one or more services, functions, or operations of the host service 102, such as (1) the operations of serving content of the collaboration tool 100 to one or more client devices communicably coupled to the host service 102, (2) generating and transmitting (or otherwise serving) notifications to one or more client devices, and (3) determining urgency scores and/or relevancy scores to bundle with one or more notifications transmitted or otherwise served to one or more client devices to be consumed by one or more particular or specified users of the collaboration tool 100.

As noted above, the host service 102 of the collaboration tool 100 can be configured, at least in part, to categorize, tag, or otherwise analyze content stored by the system in order to compare content of a notification with content previously received by the system. For example, the host service 102 can be configured to, without limitation: perform a topic modeling operation on content previously received by the system and content of a notification scheduled to be sent to a user; determine semantic similarity between content of a notification scheduled to be sent to a user to content previously received and/or otherwise stored by the system; determine grammatical similarity between content of a notification scheduled to be sent to a user to content previously received and/or otherwise stored by the system; determine sentiment similarity between content of a notification scheduled to be sent to a user to content previously received and/or otherwise stored by the system; determine metadata similarity between content of a notification scheduled to be sent to a user to content previously received and/or otherwise stored by the system which can include content creators, content editors, projects or project relationships, creation dates, edit dates, number of users interacting with particular content, seniority of users interacting with content, seniority of users interacting with content as compared against seniority of the particular user for which the notification schedule to be sent is intended; and so on. It may be appreciated that the foregoing examples are not exhaustive of the methods of comparing two bodies of text to one another to determine similarity therebetween. Other examples or natural language processing algorithms, pipelines, or techniques can be used as well in place of those examples presented above. Examples of other natural language processing algorithms or techniques that can be leveraged to determine a similarity between two bodies of text (e.g., between previously-received content and content of the notification scheduled to be sent to a specified user) can include but may not be limited to: cosine similarity; Levenshtein distance; Hamming distance; trigram calculations; Jaro-Winkler calculations; Sorensen-Dice calculations; stemming; lemmatization; tokenization; topic modeling; latent Dirichlet allocation; normalization; Jaccard similarity scoring; Ratcliff-Obershelp similarity calculations; and the like. It may be appreciated that any suitable method or methods of determining similarity between notification content and content previously received or stored by the host service 102 of the collaboration tool 100 can be used.

Independent of the method or combination of methods used to determine similarity between content of a notification scheduled to be sent to an intended recipient user and content previously received by the system, the host service 102 of the collaboration tool 100 can determine by sorting or another selection technique the most likely content, project, page, or topic that a notification refers to. For example, a notification can include a string phrase of “error received for users authenticating with the user authentication service.” In this example, the host service 102 of the collaboration tool 100 may be configured to perform a linguistic tagging operation that identifies the phrases, “error,” “users authenticating,” and “user authentication service” as a noun or verb phrases, among other potentially identifiable of tokenizable phrases or phrase types.

Thereafter, the host service 102 of the collaboration tool 100 may be configured to lemmatize or otherwise stem each word of each phrase to output the lemmatized phrases “error,” “user authenticate” and “user authentication service.” Thereafter, the host service 102 of the collaboration tool 100 can be configured to perform a topic modeling operation against content stored by, or accessible to, the host service 102 of the collaboration tool 100. For example, the host service 102 of the collaboration tool 100 may determine a strong statistical correlation between the notification of this example and a project hosted by the collaboration tool 100 entitled “Credential Service.”

In another example, the host service 102 of the collaboration tool 100 may be configured to display content, such as a message board or a wiki article. In these examples, the host service 102 and/or a client device rendering content served by the host service 102 can be configured to lemmatize or otherwise stem each word of a corpus of words extracted from said message board or article (whether displayed to the user or otherwise). Thereafter, as with other examples provided herein, the host service 102 of the collaboration tool 100 can be configured to perform a topic modeling operation against content stored by, or accessible to, the host service 102 of the collaboration tool 100.

Once content or features thereof has been extracted, the host service 102 of the collaboration tool 100 can be configured to determine two statistical likelihoods in order to determine an urgency score and a relevancy score to bundle with the notification scheduled to be sent to the intended recipient user or to display with content served by the host service 102 and displayed for the same user.

A first statistical likelihood can correspond to the relevancy score and may be based on, without limitation: how many times the intended recipient user has interacted with Credential Service project (e.g., added content, edited content, provided input or otherwise acted upon existing content, and the like); how many times, as compared against an average of all users, the intended recipient user has clicked through or dwelled or hovered on a notification related to the Credential Service project; how many times other users of the collaboration tool 100 that regularly interact with the intended recipient user have interacted with the Credential Service project; and so on. As noted above, any suitable data and/or metadata or quantity thereof can be leveraged by the host service 102 of the collaboration tool 100 to inform a statistical likelihood, such as described herein. The preceding examples are not exhaustive.

To continue the example provided above, the host service 102 of the collaboration tool 100 may query one or more databases, in particular databases that store user interaction histories and metadata of content stored by the collaboration tool to determine (1) that the intended recipient user has clicked through 15 of the past 20 notifications related to the Credential Service project, (2) that other users who regularly interact with the intended recipient user (e.g., the intended recipient user's social connections) have greater than 5 seconds of dwell time when reviewing notifications related to the Credential Service project, (3) that the intended recipient user is a member of the team that maintains the Credential Service project, (4) that the intended recipient user has a click-through rate of 95% when a notification contains a term related to “authentication,” and (5) that the intended recipient user has a click-through rate of 60% within five minutes of receiving a notification when that notification contains a term related to “error,” among other determinations. In one example, the host service 102 of the collaboration tool 100 can combine these statistical values using a suitable statistical analysis method (e.g., Bayesian inference, frequentist interpretation, averaging, and so on) into a singular value that falls within a given range. An example range is 0 to 1, but this is not exhaustive; in other embodiments a range from 1 to 100 may be used. This combined value can correspond to a determination of statistical likelihood or prediction of whether the intended recipient user is likely to interact with the notification at all. In other words, as noted above, this combined value from is a numerical representation of a relevancy score, such as described herein.

Thereafter, the system can translate the numerical relevancy score into a natural language relevancy score by quantizing the numerical score based on a predetermined set of relevancy phrases. For example, the system can determine that a numerical score from 90% to 100% should be translated to the natural language phrase “high relevance,” a numerical score from 60%-90% should be translated into the natural language phrase “moderate relevance,” a numerical score from 30%-60% should be translated into the natural language phrase “low relevance,” and a numerical score from 0% to 30% should be translated into the natural language phrase “not relevant.” It may be appreciated that these examples are not exhaustive and the ranges and phrases associated therewith may vary from embodiment to embodiment and implementation to implementation. Further, it may be appreciated that more than four different natural language phrases may be used, each of which may be associated with a particular graduated scale or other multilevel metric. Example phrases that can be used include, but are not limited to: very relevant; directly relevant; indirectly relevant; irrelevant; and so on.

Further, the system can be configured to determine a relevancy score relative to other users or other data to provide further context to the intended recipient user. For example, the system can be configured to determine a score capturing relevance to the intended recipient user's supervisor, relevance to management, relevance to subordinates or reports of the intended recipient user, relevance to a customer or client of the intended recipient user, relevance to a project, relevance to completion of a goal, and so on. In these examples, more than one relevance score can be calculated and bundled with the notification to be consumed by the intended recipient user. In other cases, more than one relevancy score can be combined together (e.g., averaged, weighted prior to averaging, and so on) to determine a combined relevancy score. As a result of this construction, a notification that may not be particularly relevant to the intended recipient user but is very relevant to that user's supervisor or a client may be associated with a higher relevancy score.

The system can be further configured, as noted with respect to other embodiments described herein, to perform a secondary statistical analysis to determine a likelihood that the intended recipient user will interact with the content of the notification within a particular time after receiving then notification. For example, the system can be configured to perform a statistical calculation—with the same or a different dataset (obtained by one or more queries or sets of queries) referenced above.

The second statistical calculation corresponds to a probability that the intended recipient user will interact with the content of the notification within a certain time of receiving and reviewing that notification. For example, the host service 102 can be configured to determine a 60% change that the intended recipient user will act on the notification within 5 minutes, and a 95% chance that the intended recipient user will act upon the notification within a day of receiving the notification.

In some embodiments, the second statistical determination may result in a probability density function correlating time to a likelihood that a user will have acted upon the notification by that time. In other cases, the second statistical determination may be a set of independent predictions, each associated with one time range (e.g., a probability density function). Independent of method or format of output, as with the relevancy score referenced above, outputs of the second statistical determination performed by the host service 102 of the collaboration tool 100 can be merged or otherwise combined into a singular value that corresponds to an urgency score, such as described herein.

Thereafter, as with the relevancy score referenced above, the system can translate the numerical urgency score into a natural language relevancy score by determining which time threshold is associated with the highest probabilities of user interaction. For example, the system can determine that a numerical score from 50% to 100% within an hour of consuming the notification should be translated to the natural language phrase “high urgency” whereas a numerical score from 40% to 100% within a day of consuming the notification should be translated into “medium urgency.”

It may be appreciated that these examples are not exhaustive and the confidence/likelihood ranges, time windows, and phrases associated therewith may vary from embodiment to embodiment and implementation to implementation. Further, it may be appreciated that more than four different natural language phrases may be used, each of which may be associated with a particular numerical score or range of numerical scores. Example phrases that can be used include, but are not limited to: immediate attention required; extremely urgent; attention not required; not urgent; and so on.

In other cases, the second statistical calculation can be informed by a due date, or a project target date associated with related content stored by, or accessed by, the host service 102 or extracted from the notification itself. For example, if the notification includes the phrase “by Friday at the latest” (or any other similar deadline-implying or deadline-setting phrase or content) the system can be configured to increase the urgency score. In other cases, if the notification includes a phrase similar to “low priority” or “don't have to worry about this,” then the urgency score can be decreased. In other cases, a determined urgency score or relevancy score can be biased based on other influencing factors such as, but not limited to: a sender of a message and a professional relationship between the sender and the intended recipient (e.g., supervisor, report, and so on); a time of day or week (e.g., urgent on Friday, not urgent on Monday); a planned absence or vacation of the intended recipient user or another person (e.g., not urgent because sender is on vacation); and so on. These examples are not exhaustive; a person of skill in the art will readily understand other methods of biasing a relevancy score or urgency score can be used.

In still further examples, the system can be configured to increase or decrease a calculated urgency score based on seniority or experience of a user who caused the notification to be generated to the intended recipient user. For example, if an action of an intern causes a notification to be generated for the intended recipient user, the system may be configured to decrease the urgency score. Alternatively, if an action of a supervisor of the intended recipient user caused the notification to be generated for the intended recipient user, the system may be configured to increase the urgency score. Other configurations are possible; it may be appreciated that an urgency score, such as described herein can be incremented or decremented in response to any number of determinations, calculations, or the like.

Further, as with the relevancy scores referenced above, the system can be configured to determine an urgency score relative to other users or other data to provide further context to the intended recipient user. For example, the system can be configured to determine a score capturing urgency to the intended recipient user's supervisor, urgency to management, urgency to subordinates or reports of the intended recipient user, urgency to a customer or client of the intended recipient user, urgency to a project, urgency to completion of a goal, and so on. In these examples, more than one urgency score can be calculated and bundled with the notification to be consumed by the intended recipient user. In other cases, more than one urgency score can be combined together (e.g., averaged, weighted prior to averaging, and so on) to determine a combined urgency score. As a result of this construction, a notification that may not be particularly urgency to the intended recipient user but is very urgency to that user's supervisor or a client may be associated with a higher urgency score.

In many embodiments, the system is configured to adjust urgency scores and/or relevancy scores over time. For example, the system may be configured to decrease an urgency score (and, correspondingly, any associated natural language presentation thereof) of a particular notification the longer that notification is not acted upon by the intended recipient user. In other cases, the urgency score may be increased as time passes; a notification that was not urgent several weeks ago may have elevated urgency as a deadline approaches.

Similarly, if the system determines that the intended recipient user is no longer working with a particular team or on a particular project, the system can ignore a calculated relevancy score and can present a decreased relevancy score (e.g., reduced by 50% or some other amount).

It may be appreciated that the method(s) or operation(s) by which the urgency or relevancy score is determined, established, maintained, or updated can vary from embodiment to embodiment but, in many examples, includes an operation of counting a number of interactions with the collaboration tool 100 with content associated with a given topic associated with content of the notification to be sent.

Example interactions that can be stored in a user interaction database which can be queried by the system to determine, increase, or decrease an urgency or relevancy score, such as described herein include, but are not limited to: clicking particular input elements associated with a particular topic; dwelling for at least a threshold period on a page including content related to a particular topic; adding content to the collaboration tool 100 associated with a particular topic; commenting in a comment thread—or, more generally, adding content to a knowledge-sharing feature of the collaboration tool 100—related to a particular topic; and so on. A user interaction database (not shown), such as referenced above, can be any suitable database or combination of databases. In one example, the user interaction database is a relational database; this is merely one example and is not required.

The user interaction database of the host service 102 can be associated with, and/or otherwise in communication with, a notification server 106, a content scoring server 108, and a content server 110.

Generally and broadly, the notification server 106 can be configured to generate notifications to be sent to particular users of the collaboration tool 100. The notifications can be any suitable notifications or notification types including email notifications, browser-based notifications, native application notifications and the like. In many examples, the notification server 106 can be configured to generate more than one type of notification and can be configured to format notifications in a different manner depending upon the type of notification required to convey particular information in a particular manner. More specifically, it may be appreciated that a native application notification may have a different form and format than an email notification.

The notification server 106 is communicably coupled to both the content server 110 and the content scoring server 108. As a result of this construction, the notification server 106 can be configured to generate a notification in response to a change in a database of the content server 110. For example, if a user of the collaboration tool 100 adds content to the collaboration tool 100, the content server 110 may register that content of the content server 110 has changed. In response, the notification server 106 can generate a notification to inform a particular intended recipient user of the change made to content stored by the content server 110. It may be appreciated that the trigger(s) that can be used to generate notifications by the notification server 106 can vary from embodiment to embodiment and implementation to implementation. For example, in some embodiments, the notification server 106 can be configured to generate a notification to a particular user or set of users every time content stored by the content server 110 changes. In other examples, the notification server 106 may access a list or database of user preferences that inform the notification server 106 and/or the content server 110 which changes to content stored by the content server 110 should be the subject of a notification of a selected or particular intended recipient user. In other words, certain users may be able to modify notification preferences.

The foregoing described communication between the notification server 106 and the content server 110 is not exhaustive of all methods by which the two modules may communicate with one another. In other examples, the content server 110 can be configured to inform or otherwise announce to the notification server 106 that content stored by the content server 110 has changed. In other examples, the content server 110 can determine when to send a notification to which user and may provide notification data to the notification server 106 to format appropriately. It is appreciated that many communication topologies and techniques are possible.

As noted above, the system further includes a content scoring server 108 that can be configured to determine urgency scores and relevancy scores, such as described herein. In particular, the content scoring server 108 can be configured to access database(s) of either or both the notification server 106 and/or the content server 110 (and, additionally, the user interaction database of the host server 102) in order to perform calculation or other determinations in the course of outputting a natural language relevancy score and a natural language urgency score to the notification server 106. Therewith, the notification server 106 can send a notification to a selected client device, such as the client device 104, in order to display the notification along with the calculated urgency score(s) and relevancy score(s).

In many embodiments, to perform these and other operations, the content scoring server 108 of the host service 102 can include a predictive model that is be trained, updated, and/or configured by analyzing a set of topics associated with, and/or extracted from, data stored in one or more databases of the collaboration tool 100 or services thereof. In other embodiments, these operations may be performed in whole or in part by a client application in communication with the collaboration tool 100. In these examples, the predictive model may be hosted in whole or in part by the client application.

Iteratively or otherwise, the predictive model of the content scoring server 108 can consume content associated with one or more previous user inputs and/or content stored by the collaboration tool 100 of a given set of previously-received previous user inputs to assemble a database or corpus of topics that can be added to and/or otherwise tracked by a user interaction database, such as described herein.

Example previous user inputs that can be supplied to the predictive model of the content scoring server 108 can include, but may not be limited to: previously opened issue requests or reports tracked by an issue tracking system in communication with the collaboration tool 100; previously closed issue requests or reports of an issue tracking system in communication with the collaboration tool 100; previous user inputs related to a particular project; previous user inputs related to a particular epic; previous user inputs related to a particular story; previous user inputs related to a particular company or company type (e.g., software development corporation, human resources corporation, project management corporation); previous user inputs in a particular forum; content of a knowledge store; content of a forum; content of a comment section; and so on.

Data extracted from such content can be consumed by the predictive model of the content scoring server 108 to train and/or define one or more operations of the predictive model of the content scoring server 108 and/or the content scoring server 108 itself and can include, but may not be limited to: issue/project/content or comment title; issue/project/content or comment description; issue/project/content or comment summary; links; relationships; dependencies; projects; tags, groups, clusters, or categorizations; and so on.

The foregoing examples are not exhaustive and it may be appreciated that other data or content may be used by a collaboration tool, such as described herein, to train, update, and/or define or inform one or more operations of the content scoring server 108 or its predictive model.

Thereafter, the data consumed by the predictive model of the content scoring server 108 can be analyzed (and, optionally, normalized, lemmatized, segmented, or otherwise preprocessed) to determine whether statistical inferences can be derived therefrom. In this manner, a database of terms and phrases (collectively, herein “keywords”) can be created—which can be stored by the user interaction database and/or the content scoring server 108—in which certain keywords used in a notification are associated with a statistical likelihood that the notification is, or should be, associated with a particular topic or tag.

In still further examples, data consumed by the predictive model of the content scoring server 108 can be analyzed in a different manner to further train or define a behavior of the content scoring server 108; for example, in some embodiments, one or more topic modeling operations (e.g., Latent Dirichlet Allocation operation(s), Non-negative Matrix Factorization operation(s), and so on). In this example, clusters of (optionally, lemmatized) words or phrases related to a particular topic model or other semantic structuring can be added to a database and flagged as associated with inputs provided by a user or reports known to be associated with at least one other input provided by a user or report or, alternatively, associated with no other inputs provided by a user or reports.

It may be appreciated that the foregoing is not exhaustive; the predictive model of the content scoring server 108 can be trained and/or defined or configured to operate in any suitable manner. Example sets of previous user inputs that can be used to train the predictive model of the content scoring server 108 can include (without limitation): all previous user inputs stored by the collaboration tool 100, regardless of client, epic, story, project, group, or otherwise; only previous user inputs associated with a particular client or business; only previous user inputs associated with a particular client or user type (e.g., large-cap companies, small-cap companies, software development companies, human resources companies, and so on); only previous user inputs associated with a particular group of users (e.g., a particular software development group); only previous user inputs associated with a particular project; only previous user inputs associated with a particular product platform (e.g., Apple iOS® software project or Google Android® software product); and so on.

The preceding examples are not exhaustive; it may be appreciated that in some embodiments training data supplied to, and consumed by, the predictive model of the content scoring server 108 can be limited, curated, or otherwise tailored in any suitable manner. Alternatively, training data can be entirely unlimited and may span different users, different instances of different collaboration tools, and so on. In different embodiments, different training data—or sets of training data—may be appropriate, preferred, or otherwise used.

For example, as noted above, the content scoring server 108 can be configured to consume content of a notification scheduled to be sent to an intended recipient user. Therewith, the predictive model of the content scoring server 108 can extract keywords, perform a text normalization operation (e.g., sentence segmentation, lemmatization, stop word removal, and so on), and/or perform one or more topic modeling operations to determine a topic or more than one topic that can be associated with the notification's content.

Thereafter, the content scoring server 108 can compare the resulting keywords, normalized text, and/or topic models (collectively, herein “extracted features”) to the previously-generated database(s) of topics, keywords, text, and/or topic models known to be associated with specific topics (collectively, herein “topic-signaling features”).

In a more simple phrasing, the content scoring server 108 can assemble a database of topic-signaling features. If a notification scheduled to be sent to an intended recipient user includes a word or phrase that is within the database of topic-signaling features, the notification can be presumed to include content in that category. For example, the words “syntax,” “format,” and “compiler,” may be determined by the content scoring server 108 as features that signal a topic of “debugging software;” if a notification scheduled to be sent to an intended recipient user any of these words, the content scoring server 108 may determine that the notification is associated with the topic of “debugging software.”

Optionally, the content scoring server 108 can also compare the features extracted from the notification to the previously-generated database(s) of keywords, text, and/or topic models known to not be associated with a particular topic (collectively, herein “topic-disqualifying features”).

In a more simple phrasing, the predictive model of the content scoring server 108 can assemble a database of topic-disqualifying features in addition to a database of topic-signaling features. If a notification provided by a user includes a word or phrase that is within the database of topic-disqualifying features, the notification can be presumed to not be associated with that topic. For example, the words “PHP”, “CSS”, and “javascript” may be determined by the content scoring server 108 as features that disqualify a notification from being associated with the topic of “HTML.”

It may be appreciated that the content scoring server 108 can compare extracted features (e.g., from a user input, existing content stored by the collaboration tool, and so on) to topic-disqualifying features and topic-signaling feature in any number of suitable ways. Examples include, but are not limited to, calculations and/or operations to determine: Levenshtein distance; cosine similarity calculation; Manhattan distance calculation; semantic similarity; lemmatized string similarity; term frequency comparison; document or field term frequency comparisons; Jaro-Winkler distance; Jaccard similarity; and the like.

Similarly, it may be appreciated that content can be extracted from a given input corpus by any suitable server, system, or combination thereof. For example, in some embodiments, an end-user device receiving notifications from the collaboration tool may be configured to extract one or more features that, in turn, may be communicated back to the content scoring server 108. In other cases, a notification server such as described herein can be configured to extract one or more features from a given input corpus. In a more simple, but not-limiting description, it may be appreciate that the various processing steps, such as (1) extracting one or more semantic features or (2) comparing said features to one or more entries in a database such as a topic-signaling feature database or a topic-disqualifying feature database, can be performed server-side, client-side, or any suitable combination thereof.

In many cases, a comparison leveraged by the content scoring server 108 can output a similarity value or score that can be compared against a similarity threshold to determine whether an extracted feature is sufficiently similar to a topic-signaling feature and/or a topic-disqualifying feature.

It may be appreciated that such similarity thresholds can vary from embodiment to embodiment and from comparison technique or method to comparison technique or method. For example, a similarity threshold related to a Levenshtein distance calculation may be different from a similarity threshold related to a cosine similarity calculation.

Once a determination is made by the content scoring server 108—and/or another subsystem or module of the host service 102—that a particular extracted feature is sufficiently similar to one or more relationship-signaling and/or topic-disqualifying features, the content scoring server 108 can determine and output a statistical confidence or value that corresponds to a likelihood that the notification scheduled to be sent to the intended recipient user is associated with a particular topic.

For example, the content scoring server 108 may determine that the notification scheduled to be sent to the intended recipient user includes four extracted features that are sufficiently similar to entries in a topic-signaling feature database associated with the topic of “SMTP Server” and also includes two extracted features that are sufficiently similar to entries in a topic-signaling feature database associated with the topic of “Databases.” In this example, the content scoring server 108 may determine a high likelihood that, because more features are associated with the topic of “SMTP Server,” that the notification is associated with the topic of “SMTP Server”. Similarly, the content scoring server 108 may determine a low likelihood that, because fewer features are associated with the topic of “Databases” that the user input does not substantively correspond to the topic of “Databases”.

Thereafter, the determined likelihood(s) can be compared to one or more confidence threshold(s). Upon determining that the determined likelihood(s) output from the content scoring server 108 satisfy the confidence threshold(s)—which may vary from embodiment to embodiment—the content scoring server 108 can readily identify similar content already received by the collaboration tool 100.

Upon determining that the notification is associated with a particular topic, the content scoring server 108, and/or another portion of the collaboration tool 100, can query the user interaction database with the topic and can forward results of that query back to the content scoring server 108. With this information, the content scoring server 108 can determine how many user interaction events—whether performed by the intended recipient user or other users of the collaboration tool 100 (e.g., colleagues of the intended recipient user , supervisors of the intended recipient user, subordinates or reports of the intended recipient user, or users unassociated with the intended recipient user, and so on)—occurred to content similar to the notification.

Leveraging this information, along with other information extracted from the notification or from other databases in communication with the content scoring server 108, the content scoring server 108 can calculate or otherwise determine an urgency score and a relevancy score for the intended recipient user regarding the specific content of the notification scheduled to be sent to that intended recipient user. Thereafter, the content scoring server 108 can signal the notification server 108 with the urgency score(s) and relevancy score(s). The notification server 108 can thereafter bundle the urgency score(s) and relevancy score(s) received form the content scoring server 108 and can cause a notification, and its associated urgency score(s) and relevancy score(s), to be displayed on a client device associated with the intended recipient user.

It may be appreciated that the foregoing examples are not exhaustive. More generally and broadly, it is appreciated that the collaboration tool 100 and in particular the content scoring server 108 of the collaboration tool 100 can be configured to leverage, utilize, or employ any suitable pattern recognition or classification algorithm, probabilistic model, machine learning technique (whether trained or untrained), artificial intelligence method, or any suitable combination thereof, to detect, define, determine, or otherwise infer one or more patterns in, and/or logical or causal relationships between specified or extracted topics, different user inputs, different issue content, successions or sequences of issues, or groups of issues reported to the collaboration tool 100 and how those topics have been interacted with by various users of the collaboration tool 100 over time.

Accordingly, it is appreciated that the foregoing embodiment depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

For example, the collaboration tool 100 of FIG. 1 can be implemented in a number of suitable ways. As illustrated, the host service 102 includes one or more purpose-configured modules or components each configured to perform a discrete task associated with the operation of the collaboration tool 100.

In particular, as noted above, the host service 102 includes a notification server 106, a content scoring server 108, and a content server 110. It may be appreciated that although these functional elements are identified as separate and distinct “servers” that each include allocations of physical or virtual resources (identified in the figure as the resource allocations 106a, 108a, and 110a respectively)—such as one or more processors, memory, and/or communication modules (e.g., network connections and the like)—that such an implementation is not required. More generally, it may be appreciated that the various functions described herein of a host service 102 can be performed by any suitable physical hardware, virtual machine, containerized machine, or any combination thereof.

The foregoing embodiment depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

For example, it may be appreciated that a notification rendered, shown, displayed, or otherwise accessed by or generated by a client device, such as the client device 104, can take any number of suitable forms.

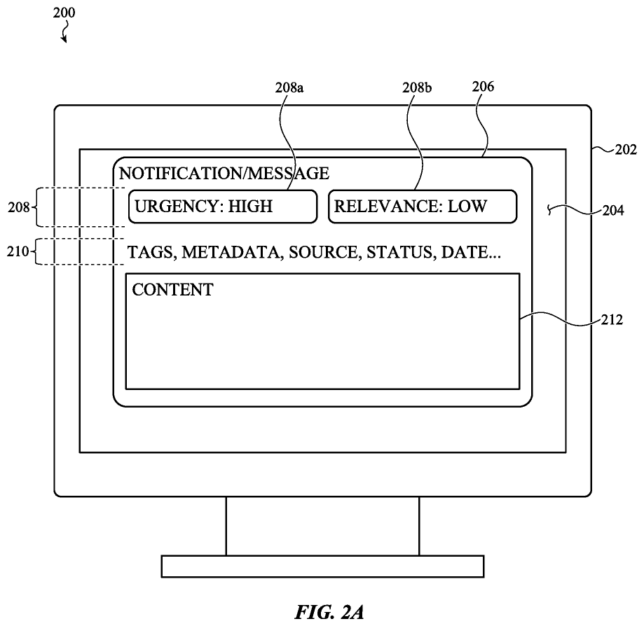

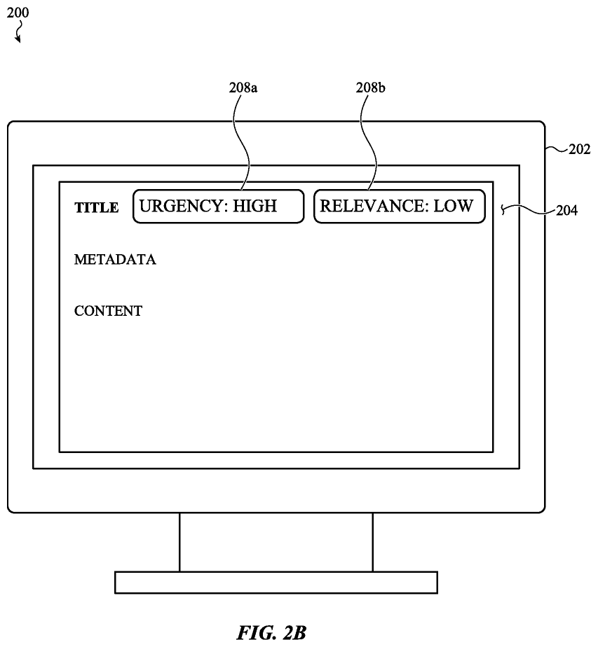

For example, FIG. 2A depicts a collaboration tool interface 200 that can be rendered or otherwise shown by a client application executed on a client device 202 as described above with respect to FIG. 1. The collaboration tool interface 200 can include a number of sections, segments, or areas that are associated with different selectable options, different information, or different tools that may be available to a user of the collaboration tool interface 200.

In this embodiment, the client device 202 is configured to render a native application that, in turn, can display a notification 206. The notification 206 may be received from a notification server of a collaboration tool, such as described above. The notification 206 can be displayed with all content received by the client device 202 or, in other cases, the notification 206 can be displayed with partial content, such as a summary. The summary can be received by or determined by the client device 202.

The notification 206 in this embodiment includes an upper section 208 in which one or more urgency scores or relevancy scores—that were calculated or otherwise determined by a content scoring server such as described above in reference to FIG. 1—can be displayed. In particular, in the illustrated embodiment, a natural language urgency score 208a is shown in line with a natural language relevancy score 208b. In this example embodiment, the urgency score(s) and the relevancy score(s) are rendered or otherwise shown above content of the notification 206. Other content of the notification 206 can include metadata information, identified as the metadata information line 210, and/or content information such as the notification content 212 (which may be partial or complete). In some cases, the notification 206 can be displayed in a manner informed by the urgency score and the relevancy score shown with the notification content 212. For example, if the relevancy score (or the numerical equivalent thereof) exceeds a threshold value, the notification 206 can be displayed as a banner notification. In other cases, if the relevancy score exceeds another threshold higher than the first, the notification 206 can be displayed as a prioritized notification (e.g., shown on a lock screen of the client device). In other cases, the way in which the notification 206 is displayed (e.g., along with sounds, visual emphasis, colors, font size, and so on) can vary based on the urgency score, the relevancy score, or any stuitable combination thereof (e.g., a product thereof).

In another example embodiment, shown in FIG. 2B, a collaboration tool interface 200 can be rendered or otherwise shown by a client application executed on a client device 202, such as shown in FIG. 2A. In this embodiment, the collaboration tool interface 200 can be configured to display, serve, or otherwise render a page/user interface that presents a layout of information to a user of the client device 202. For example, the user interface 204 may be configured to display content associated with a knowledge sharing feature of a collaboration tool. Example, knowledge sharing features include, but are not limited to: wiki pages; comment sections; code documentation; and so on. In this embodiment, a natural language urgency score 208a is shown in line with a natural language relevancy score 208b, each of which are shown in line with the content of the page rendered by the user interface 204.

This foregoing example embodiment is merely one example in which an urgency score and a relevancy score is displayed for the benefit of a user in a prominent position relative to content of that notification.

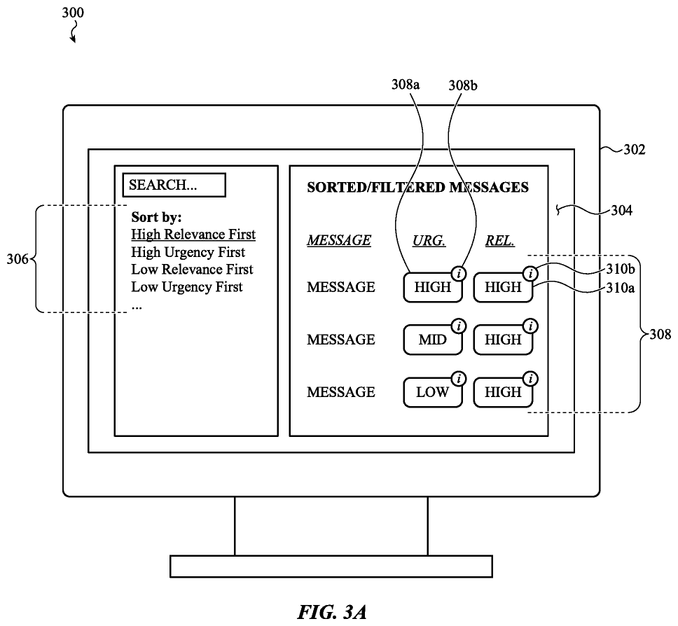

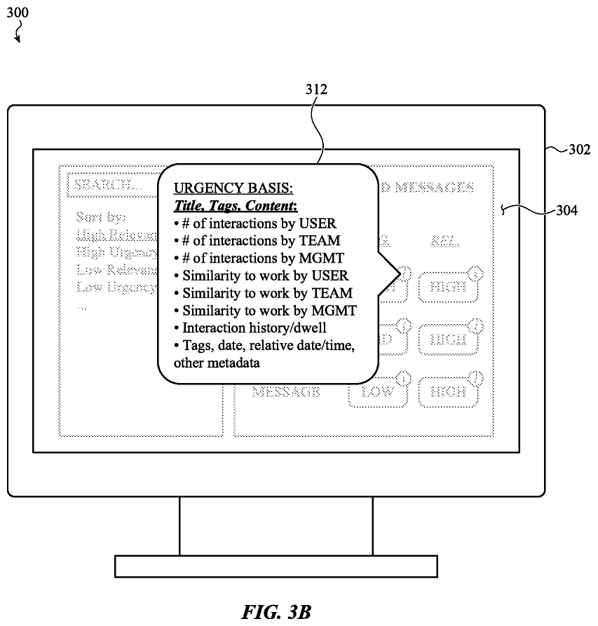

For example, FIG. 3A depicts another example user interface that may be associated with a collaboration tool, such as described herein. As with the embodiment depicted in FIG. 2A, the collaboration tool interface 300, rendered by a client device 302, includes a graphical user interface 304 that can provide a method of sorting a set of notifications to consumption by the user. In particular, the graphical user interface 304 includes an input region 306 that can be used by a user of the client device 302 to select a sorting of notifications to be displayed in a second input region 308. In the illustrated embodiment, it is selected in the input region 306 that notifications with high relevance are displayed first. As such, in the input region 308, notifications with a higher relevance (as determined by a content scoring server, such as described above) are displayed above notifications with a lower relevance. In these embodiments, a numerical representation of the urgency and relevancy scores may be used for sorting whereas the natural language representations of the urgency and relevancy scores may be displayed to the user.

In this example embodiment, urgency and relevance scores can be accompanied by contextual information about the meaning and/or justification for those scores. For example, the highest “priority” notification displayed in the input region 308 includes a graphical user interface element 308a to indicate that the notification has a high urgency and a graphical user interface element 310a to indicate that the notification has a high relevancy. Both of these graphical user interface elements are accompanied by a button (for example, the buttons 308b and 310b) that, if pressed by a user, can provide additional context and/or content to the user to determine how and why the selected message is a high urgency and high relevance message. For example, FIG. 3B depicts the user interface of FIG. 3A also depicting a context overlay 312 that depicts a number of example variables that contributed to the system's determination that the notification is a high urgency notification.

The preceding example user interface(s) depicted in FIGS. 2-3B are not exhaustive of the different ways that an urgency score and a relevancy score can be shown or otherwise displayed to a user of a collaboration tool, such as described herein. It may be appreciated that as a result of the operations to determine urgency and relevance, a specified user can be shown an easy-to-understand urgency rank and an easy-to-understand relevancy rank. The specified user can leverage these urgency and relevance scores/ranks to automatically triage which notification among a set of unconsumed notifications should be consumed and/or acted upon by the specified user first. For example, the specified user may opt to act in response to notifications marked with a high urgency score (e.g., “highly urgent,” “very urgent,” “immediate attention required,” and so on) prior to notifications marked with a high relevancy score (e.g., “very relevant,” “of interest,” “may be interesting,” and the like). Alternatively, the specified user map opt to act in response to notifications that are both scored with a high relevancy score and a high relevancy score. In some cases, the specified user may be additionally presented with a combined “priority” score that may be derived according to any suitable formula based on the urgency score and the relevancy score. For example, in some embodiments, the priority score may represent a third natural language descriptor that corresponds to a product of the first and second probability metric.

As a result of this operation, and other similar operations, the priority score, the urgency score, and/or the relevancy score can be used as a sorting mechanism by the specified user to elevate notifications most likely to be acted upon by that user to a prominent position (e.g., top) among a list of notifications received by the specified user. In other cases, notifications having an urgency score, priority score, or relevancy score that satisfies a given threshold (which may be static or may vary from user to user) may be visually emphasized when displayed to the specified user. For example, notifications having a high urgency score may be colored red or may be animated to flash to draw the attention of the specified user to the high urgency notification. Similarly, notifications having a medium or high relevancy score may be color coded to assist the specified user in visually distinguishing between notifications of differing relevance.

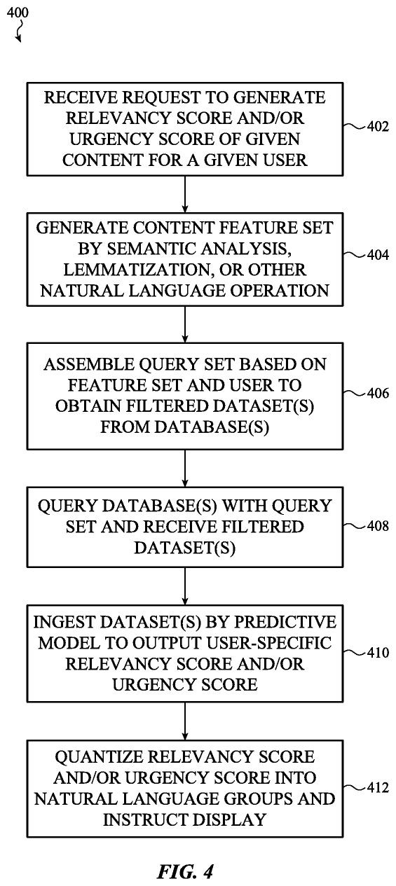

FIG. 4 depicts example operations of a method of operating a content scoring server of a collaboration tool, such as described herein.

The method 400 can be performed by a content scoring server, such as the content scoring server 108 described in reference to FIG. 1 and other embodiments presented and described herein. In particular, the method can be performed in whole or in part by a processor or processor allocation associated with a content scoring server—or other module of a host service—such as described herein.

The method 400 includes operation 402 in which the content scoring server—or another component in communication therewith such as a client device—receives a request to generate a relevancy score and/or an urgency score for given content for a given user of the collaboration tool.

The method 400 also includes optional operation 404 in which one or more semantic features, grammatical features, or other linguistic features are extracted from the content received at operation 402. The feature extracted can include, without limitation: topic-signaling features; topic-disqualifying features; lemmatized terms; tokenized words; topic models; and so on.

The method 400 further includes operation 406 at which a query set is constructed based on the features extracted at operation 404. In many examples, such as noted above, the operation 406 can be performed by generating a query compatible with a database structure and query format of a user interaction database. The query set can include one or more queries.

The method 400 further includes operation 408 at which at least one query of the query set are submitted to a database, such as a user interaction database. In other cases, at least one query of the query set is submitted to another database, such as a third party database, to obtain data that informs an urgency or relevancy calculation.

The method 400 further includes operation 410 at which the data (referred to herein as dataset(s)) received as a result of the queries executed at operation 408 can be ingested by a predictive model or other input or data ingest module of a content scoring server of a collaboration tool such as described herein. As described above, the predictive model can be configured to generate a score corresponding to a predicted urgency of the given content of the given notification to the given user and, additionally, a score corresponding to a predicted relevance of the given content of the given notification to the given user.

Finally, at operation 412, the method can operate to translate the scores generated at operation 410 into natural language phrases. As with other embodiments described herein, this operation can be performed in a number of suitable ways. For example, the score(s) can be quantized into discrete groups and thereafter associated with a natural language phrase corresponding to one of said groups. In another example, the score(s) can be translated by an algorithm configured to make a relativistic determination based on other notifications received by the same user. For example, if the user has received five notifications all related to different content, the system can be configured to identify that the highest urgency among the five notifications is a “high urgency” notification, independent of the underlying numerical urgency score associated with that notification.

It is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

Accordingly, one may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A method for operating a content scoring server of a collaboration tool to autonomously generate a natural language relevancy rank and urgency rank of specified content to be displayed to a specified user of the collaboration tool, the method comprising:
receiving, at the content scoring server, a first data item comprising the specified content and a second data item corresponding to the specified user;
extracting a content feature set from the first data item;
ingesting by a predictive model the second data item and the content feature set;
receiving, from the predictive model:
a first probability metric representing a likelihood that the specified user will interact with the specified content; and
a second probability metric representing a likelihood that the specified user will interact with the specified content within a threshold period of time;
determining, by the content scoring server, a relevancy rank by selecting a first natural language descriptor based on the first probability metric;
determining, by the content scoring server, an urgency rank by selecting a second natural language descriptor based on the second probability metric;
instructing a notification server to generate a notification to the specified user, the notification comprising the specified content, the relevancy rank, and the urgency rank; and
displaying the notification to the specified user by displaying the relevancy rank and the urgency rank to the specified user.

2. The method of claim 1, wherein extracting the content feature set from the first data item is performed by one or more of the content scoring server or a client application configured to display the notification.

3. The method of claim 1, further comprising:
generating a query set with at least one of the content feature set and the second data item;
querying, by the content scoring server, at least one database with at least one query of the query set to obtain a query result comprising at least one of:
a first dataset of user interaction events corresponding to interactions by the specified user with content comprising at least one feature of the content feature set; and
a second dataset of user interaction events corresponding to interactions by at least one other user of the collaboration tool with content comprising at least one feature of the content feature set; and
ingesting by the predictive model the second data item, the query result, and the content feature set.

4. The method of claim 3, wherein the query result comprises at least two of:
the first dataset;
the second dataset;
a third dataset comprising metadata describing at least one feature of the content feature set; and
a fourth dataset comprising a tag assigned by the specified user describing at least one feature of the content feature set.

5. The method of claim 3, wherein:
the query results comprises first dataset; and
at least one user interaction event comprises a dwell time of the specified user relative to content comprising at least one feature of the content feature set.

6. The method of claim 3, wherein:
the query results comprises second dataset; and
the at least one other user is a member of team comprising the specified user.

7. The method of claim 1, wherein:
the notification server is configured to communicate with a client device executing the client application and associated with the specified user and communicably coupled to the collaboration tool; and
the notification server is configured to instruct the client device to display the notification to the specified user.

8. The method of claim 7, wherein the client device is configured to display the urgency rank and the relevancy rank in addition to at least a portion of the specified content.

9. The method of claim 8, wherein the at least a portion of the specified content comprises one or more of:
a content title;
a metadata item describing the specified content;
at least one content feature of the content feature set; and
a content body.

10. The method of claim 1, wherein:
the first natural language descriptor is one of high, medium, low, or not relevant; and
the second natural language descriptor is one of high, medium, low, or not urgent.

11. A content scoring server in communication with a collaboration tool platform and comprising:
a networking resource allocation;
a memory resource allocation;
a processor resource allocation in communication with the memory resource allocation and the networking resource allocation, the processor configured to execute instructions retrieved from the memory resource allocation to:
receive, at the processor resource allocation, the specified content and an indication of the specified user;
generate at least one query, by the processor resource allocation, based on at least one semantic feature of the specified content and based on the specified user;
submit the at least one query, by the processor resource allocation via the networking resource allocation, to a database to obtain a result comprising at least one of a dataset of user interaction events corresponding to interactions by the specified user and other users of the collaboration tool platform with content comprising the at least one sematic feature of the specified content;
ingest by a predictive model loaded from the memory resource allocation by the processor resource allocation, the query result and the indication of the specified user;
receiving, from the predictive mode:
a first probability metric representing a likelihood that the specified user will interact with the specified content; and
a second probability metric representing a likelihood that the specified user will interact with the specified content within one of a set of threshold periods of time; and
initiating, by the processor resource allocation, a process to cause a notification to be displayed to the specified user at a client device of the specified user, the notification comprising the at least a portion of the specified content, the first probability metric, and the second probability metric.

12. The content scoring server of claim 11, wherein the processor allocation is configured to:
translate the first probability metric to a first natural language descriptor;
translate the second probability metric to a second natural language descriptor; and
the notification comprises the first natural language descriptor and the second natural language descriptor.

13. The content scoring server of claim 11, wherein at least one threshold of the set of threshold periods of time is satisfied when the specified user interacts with the specified content within an hour of the notification being shown to the specified user.

14. The content scoring server of claim 11, wherein at least one threshold of the set of threshold periods of time is satisfied when the specified user interacts with the specified content within a week of the notification being shown to the specified user.

15. The content scoring server of claim 11, wherein the processor allocation comprises a physical processor.

16. The content scoring server of claim 11, wherein the specified content is associated with a task assigned to the specified user that is related to a project or a knowledge-sharing feature tracked by the collaboration tool.

17. A method for autonomously generating and displaying, in natural language, an urgency score corresponding to a prediction of whether specified content to be displayed to a specified user of a collaboration tool is likely to require the urgent attention of the specified user, the method comprising:
receiving the specified content and an indication of the specified user;
extracting at least one semantic feature from the specified content;
querying a database of user interaction events corresponding to interactions by users of the collaboration tool with content comprising the at least one semantic feature extracted from the specified content to obtain a dataset of user interaction events corresponding to interactions by the specified user and other users of the collaboration tool with the content comprising the at least one semantic feature extracted from the specified content;
receiving by a predictive model the dataset and the indication of the specified user;
generating by the predictive model from the dataset and the indication of the specified user, a probability metric representing a likelihood that the specified user will interact with the specified content within one of a set of increasing threshold periods of time;
translating the probability metric into the urgency score, the urgency score comprising a natural language phrase based on a magnitude of the probability metric; and
generating a notification to the specified user, the notification comprising the specified content and the natural language phrase.

18. The method of claim 17, wherein the natural language phase is selected from the English language phrase group:
high urgency;
low urgency;
medium urgency;
not urgent; and
not relevant.

19. The method of claim 17, wherein the at least one semantic feature comprises one or more of:
a topic model derived from the specified content;
a word count of the specified content;
a sentence count of the specified content;
a keyword list extracted from the specified content;
a name or alias identifying the selected user extracted from the specified content;
a name or alias identifying a supervisor of the selected user extracted from the specified content;
a name or alias identifying a subordinate of the selected user extracted from the specified content;
a name or alias of a project tracked by the collaboration tool extracted from the specified content; and
a sentiment analysis of at least a portion of the specified content.

20. The method of claim 17, wherein the notification comprises an email notification.
